(19) United States
(12) Patent Application Publication
(10) Pub. No.: US 2008/0176657 A1
(43) Pub. Date: Jul. 24, 2008

(54) Gaming machine in which a plurality of players can participate and the control method thereof

(75) Inventor: Kazuo Okada, Tokyo (JP)

Correspondence Address: NDQ&M WATCHSTONE LLP, 1300 EYE STREET, NW, SUITE 1000 WEST TOWER, WASHINGTON, DC, 20005, US

(73) Assignee: ARUZE GAMING AMERICA, INC., Las Vegas, NV (US)

(21) Appl. No.: 11/889,691

(22) Filed: Aug. 15, 2007

Related U.S. Application Data
(60) Provisional application No. 60/881,494, filed on Jan. 22, 2007.

(51) Int. Cl. A63F 13/00

(52) U.S. Cl. 463/42; 463/21

(57) ABSTRACT

A gaming machine has a plurality of displays for respectively displaying a plurality of games in which a plurality of players can participate, and a plurality of client terminals for accepting betting operations for betting gaming media with respect to each of the plurality of games. The plurality of client terminals are moved such that it becomes easier for a player of each client terminal at which a betting operation is made to view a display which displays a game with respect to which the betting operation is made.

### CROSS REFERENCE TO RELATED APPLICATIONS

This application claims priority to co-pending U.S. provisional patent application Ser. No. 60/881,494 filed on Jan. 22, 2007, and which is incorporated by reference herein for all purposes.

### BACKGROUND OF THE INVENTION

1. Field of the Invention

The present invention relates to a gaming machine for playing a game by using gaming media such as coins, bills, etc., and a control method of a gaming machine.

2. Description of the Related Art

Conventionally, a gaming machine for executing a game in which a plurality of players make bets of credits from client terminals has been known. In US2005/0059474A1, US2005/0282618A1, and US2005/0218590A1, a gaming machine in which a plurality of client terminals, a central controller and a common display unit are connected has been disclosed.

### SUMMARY OF THE INVENTION

The first aspect of the present invention is a gaming machine having a configuration described below. Namely, the above described gaming machine has a plurality of displays configured to respectively display a plurality of games in which a plurality of players can participate; a plurality of client terminals configured to accept betting operations for betting gaming media with respect to each of the plurality of games; a moving device configured to move the plurality of client terminals; and a controller operable to control the moving device to move the plurality of client terminals such that it becomes easier for a player of each client terminal at which a betting operation is made to view a display which displays a game with respect to which the betting operation is made.

According to the first aspect of the present invention, a player can bet with respect to a plurality of games, and the client terminal will be moved such that a display of a game that is a target of the betting operation becomes easier to view.

The second aspect of the present invention is a gaming machine having a configuration described below. The above described gaming machine has a plurality of displays configured to respectively display a plurality of games in which a plurality of players can participate; a plurality of client terminals configured to accept betting operations for betting gaming media by guessing a game result of each of the plurality of games; a moving device configured to move the plurality of client terminals; and a controller operable to carry out (a) and (b) described below. This controller (a) controls the moving device to move the plurality of client terminals such that it becomes easier for a player of each client terminal at which a betting operation is made to view a display which displays a game with respect to which the betting operation is made, and (b) starts a game after a moving of the plurality of client terminals is completed.

According to the second aspect of the present invention, a player can bet with respect to a plurality of games, and the client terminal will be moved such that a display of a game that is a target of the betting operation becomes easier to view. Then, a game will be started after a moving is completed.

The third aspect of the present invention is a gaming machine having a configuration described below. The above described gaming machine, has a plurality of displays configured to respectively display a plurality of games in which a plurality of players can participate; a plurality of client terminals configured to accept betting operations for betting gaming media by guessing a game result of each of the plurality of games; a moving device configured to move the plurality of client terminals; and a controller operable to carry out (a) to (c) described below. This controller (a) measures a period for accepting the betting operations, (b) controls the moving device to move the plurality of client terminals such that it becomes easier for a player of each client terminal at which a betting operation is made to view a display which displays a game with respect to which the betting operation is made after the period for accepting the betting operations is finished, and (c) starts a game after a moving of the plurality of client terminals is completed.

According to the third aspect of the present invention, a player can bet with respect to a plurality of games, and the client terminal will be moved such that a display of a game that is a target of the betting operation becomes easier to view. In particular, a moving of the client terminals will be carried out after the period for accepting the betting operations is finished. Then, a game will be started after a moving is completed.

The fourth aspect of the present invention is a method for controlling a gaming machine having a configuration described below. The above described method for controlling a gaming machine accepts betting operations for betting gaming media from a plurality of client terminals, with respect to each of a plurality of games in which a plurality of players can participate through the plurality of client terminals; judges a display for displaying a game with respect to which a betting operation is made, among a plurality of displays configured to respectively display the plurality of games; and moves the plurality of client terminals such that it becomes easier for a player of each client terminal at which a betting operation is made to view a display which displays a game with respect to the betting operation is made, according to judgement results.

According to the fourth aspect of the present invention, a player can bet with respect to a plurality of games, and the client terminal will be moved such that a display of a game that is a target of the betting operation becomes easier to view.

The fifth aspect of the present invention is a method for controlling a gaming machine having a configuration described below. The above described method for controlling a gaming machine accepts betting operations for betting gaming media from a plurality of client terminals, with respect to each of a plurality of games in which a plurality of players can participate through the plurality of client terminals; judges a display for displaying a game with respect to which a betting operation is made, among a plurality of displays configured to respectively display the plurality of games; moves the plurality of client terminals such that it becomes easier for a player of each client terminal at which a betting operation is made to view a display which displays a game with respect to the betting operation is made, according to judgement results; and starts a game after a moving of the plurality of client terminals is completed.

According to the fifth aspect of the present invention, a player can bet with respect to a plurality of games, and the client terminal will be moved such that a display of a game that is a target of the betting operation becomes easier to view. Then, a game will be started after a moving is completed.

The sixth aspect of the present invention is a method for controlling a gaming machine having a configuration described below. The above described method for controlling a gaming machine accepts betting operations for betting gaming media from a plurality of client terminals, with respect to each of a plurality of games in which a plurality of players can participate through the plurality of client terminals; judges a display for displaying a game with respect to which a betting operation is made, among a plurality of displays configured to respectively display the plurality of games, after a period for accepting the betting operations is finished; moves the plurality of client terminals such that it becomes easier for a player of each client terminal at which a betting operation is made to view a display which displays a game with respect to the betting operation is made, according to judgement results; and starts a game after a moving of the plurality of client terminals is completed.

According to the sixth aspect of the present invention, a player can bet with respect to a plurality of games, and the client terminal will be moved such that a display of a game that is a target of the betting operation becomes easier to view. In particular, a moving of the client terminals will be carried out after the period for accepting the betting operations is finished. Then, a game will be started after a moving is completed.

### BRIEF DESCRIPTION OF THE DRAWINGS

FIG. 1 is a flow chart showing a control method of a gaming machine according to an embodiment of the present invention.

FIG. 2 is a diagram showing an outward appearance of a schematic configuration of a gaming machine according to the present embodiment.

FIG. 3 is a schematic configuration diagram showing an entire gaming machine.

FIG. 4 is a configuration diagram showing details of a roulette board.

FIG. 5 is a perspective view of a client terminal.

FIG. 6 is a block diagram showing an internal configuration of a first game controller.

FIG. 7 is a block diagram showing an internal configuration of a second game controller.

FIG. 8 is a block diagram showing an internal configuration of a third game controller.

FIG. 9 is a block diagram showing an internal configuration of a client terminal.

FIG. 10 is a block diagram showing an internal configuration of a relay controller.

FIG. 11 is a flow chart showing the operation of a first game controller.

FIG. 12 is a flow chart showing the operation of a second game controller.

FIG. 13 is a flow chart showing the operation of a third game controller.

FIG. 14 is a first flow chart showing the operation of a client terminal and a moving device.

FIG. 15 is a second flow chart showing the operation of a client terminal and a moving device.

FIG. 16 is a first flow chart showing the operation of a relay controller.

FIG. 17 is a second flow chart showing the operation of a relay controller.

FIG. 18 is a third flow chart showing the operation of a relay controller.

FIG. 19 is a diagram showing one example of a moving of client terminals.

### DETAILED DESCRIPTION OF AN EMBODIMENT

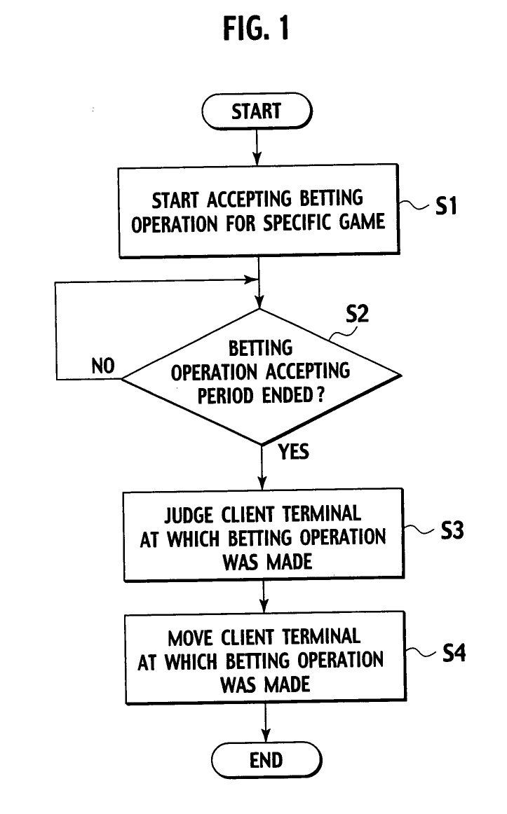

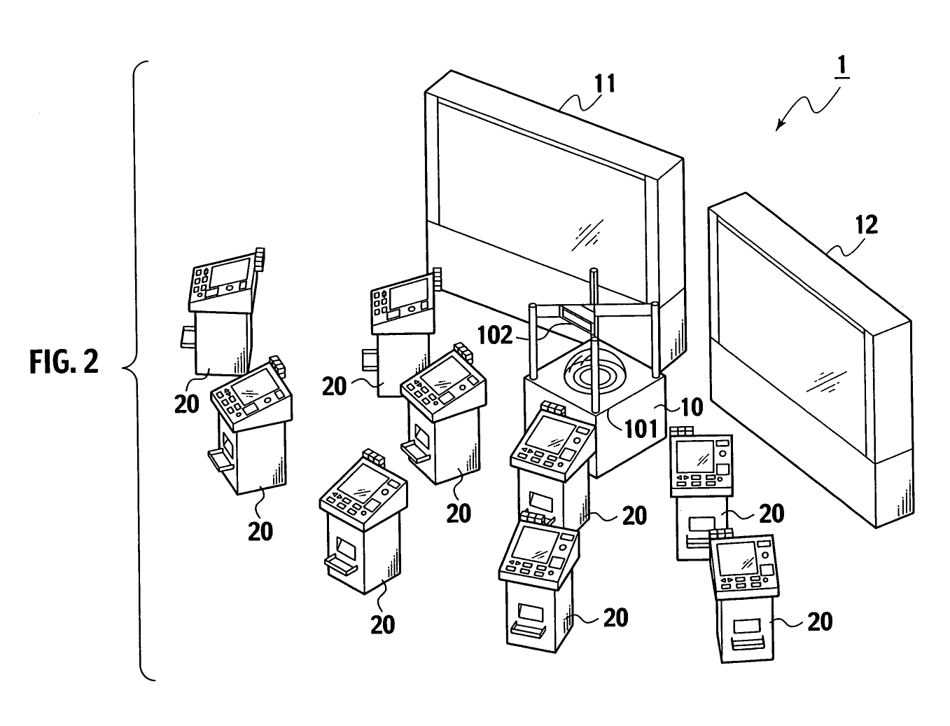

FIG. 1 is a flow chart showing a control method of a gaming machine according to an embodiment of the present invention, and FIG. 2 is a diagram showing an outward appearance of a schematic configuration of a gaming machine according to the present embodiment.

As shown in FIG. 2, the gaming machine 1 according to the present embodiment is capable of playing three games in which a plurality of players can participate. A game to be executed by the gaming machine 1 is one in which a plurality of players makes bets by guessing a result of one game and a payout is made according to a game result of one game and respective betting states of the plurality of players, as exemplified by a roulette game and a horse racing game. It can also be one in which payouts are made according to exchanges between a plurality of players and one dealer (including a dealer displayed as an image), as in a poker game or a black jack game.

The gaming machine 1 according to the present embodiment is capable of playing three such games. Note that the following embodiment will be described for case where one of the three games is a “roulette game”, another one is a “horse racing game”, and a remaining one is a “slot game”. Here, the slot game is a game in which a plurality of players consider which payline on one slot such as that of three rows by three columns should be bet, and receive the payouts of credits when symbols are aligned on the bet payline.

In the gaming machine 1 as described above, which game is to be selected and played by the player depends on the player, so that there is a need to make it possible to view three games from the player location. For example, as shown in FIG. 2, suppose that three of a roulette display device 10, a horse racing game display device 11 and a slot game display device 12 exist. In this case, a plurality of client terminals 20 at which the players makes betting operations and the like must be arranged such that all the display devices 10 to 12 can easily be viewed from the players.

However, there is a limit to the space for arranging the plurality of client terminals 20, so that the players may have a poor capability of viewing the display devices 10 to 12 of the respective games depending on the arrangement state. For this reason, the gaming machine 1 according to the present embodiment has a configuration in which the plurality of client terminals 20 will be moved. This point will be described now.

As shown in FIG. 1, in the gaming machine 1, the acceptance of the betting operations for one game among the three games is started first (step S1). Here, the game for which the acceptance is started will be referred to as a “specific game” in the description of FIG. 1.

Next, the gaming machine 1 judges whether the acceptance period for the specific game has finished or not (step S2). When it is judged that the acceptance period for the specific game has not finished (step S2: NO), the gaming machine 1 repeats this processing until it is judged as finished. On the other hand, when it is judged as finished (step S2: YES), the gaming machine 1 judges the client terminals 20 at which the betting operations for the specific game have been made (step S3).

After that, the gaming machine 1 moves the client terminals 20 at which the betting operations for the specific game have been made (step S4). At this point, the client terminal 20 is moved such that it becomes easier for the player to view the display devices 10 to 12 of the specific game. For example, then client terminal 20 is moved closer to the display devices 10 to 12 of the specific game, or moved to face against them. In this way, it is possible to improve the capability of viewing the display devices 10 to 12 of the games.

After that, the processing shown in FIG. 1 is finished. Note that, in FIG. 1, the exemplary case of the specific game has been described, but the gaming machine 1 executes the similar processing for the other games as well. Namely, the gaming machine 1 executes the same processing as FIG. 1 with respect to each one of the three games, and moves the client terminals 20.

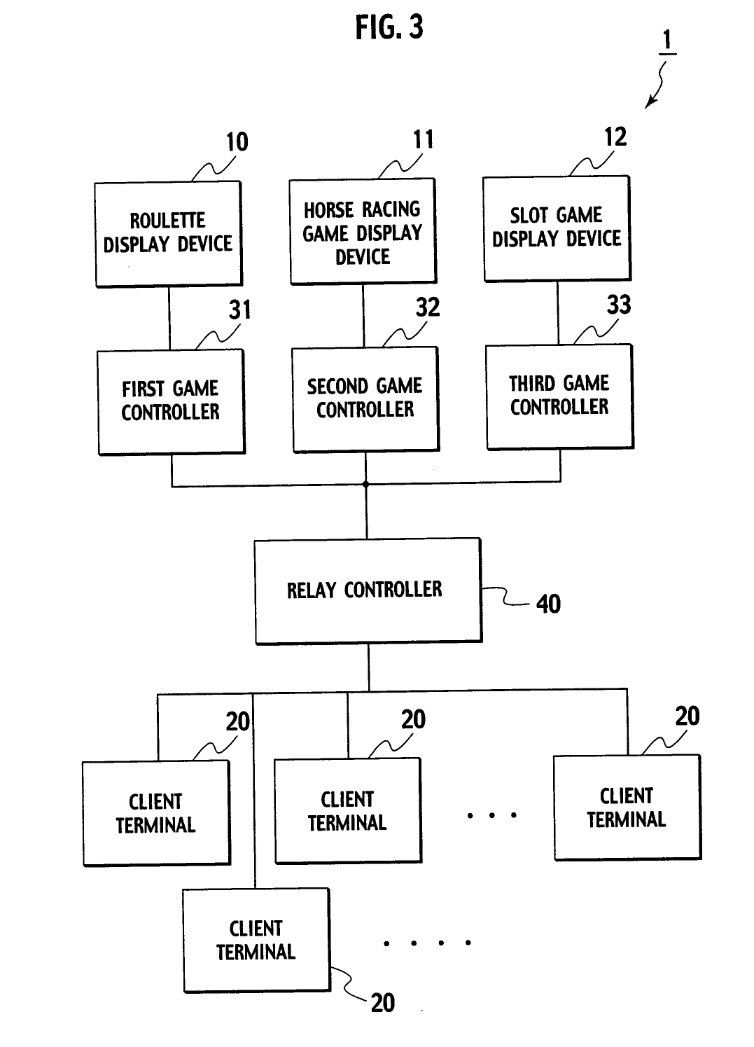

Next, the configuration of each part of the gaming machine 1 will be described in detail. FIG. 3 is a schematic configuration diagram showing the entire gaming machine 1. As shown in FIG. 3, the gaming machine 1 comprises a plurality of display devices 10 to 12, a plurality of client terminals 20, first to third game controllers 31 to 33, and a relay controller 40.

The plurality of display devices 10 to 12 are for respectively displaying a plurality of games in which a plurality of players can participate. Among them, a roulette display device 10 is for making a game content viewable by the players by a mechanical configuration. A horse racing game display device 11 and a slot game display device 12 are for making game contents viewable by the players by a large scale display.

As also shown in FIG. 2, the roulette display device 10 has a circular roulette board 101 provided on a cubic shaped base, and a jackpot display unit 102 attached to an arch located on an upper side of the roulette board 101. The jackpot display unit 102 is for displaying an amount of credits to be paid at a prescribed probability or in a case where a bonus game that is generated when a prescribed condition is satisfied is won.

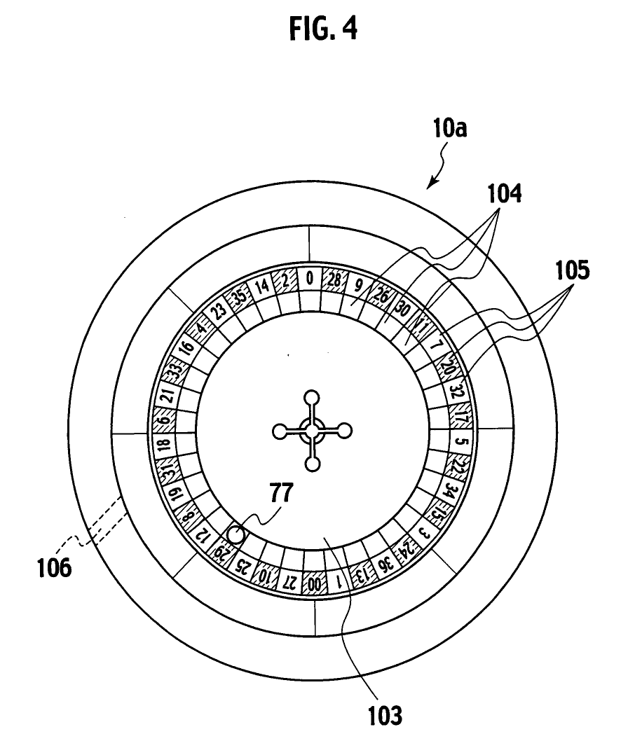

FIG. 4 is a configuration diagram showing details of the roulette board 101. The roulette board 101 comprises a roulette wheel 103, number pockets 104, and number display plates 105. The roulette wheel 103 is supported to be rotatable, and on an upper surface of the roulette wheel 103, 38 of the number pockets 104 in concave shape are formed. In addition, on an upper surface of the roulette wheel 103 in an outward direction of the number pockets 104, the number display plates 105 for displaying numbers “0”, “00”, “1” to “36” in correspondence to the respective number pockets 104 are formed.

The roulette board 101 has such a configuration that it is driven by a driving motor (not shown) to rotate. The roulette board 101 has a gentle slope formed thereon. When a ball is entered from a ball entering hole 106, the ball loses the centrifugal force as the rotational speed decreases, and falls into one of the number pockets 105.

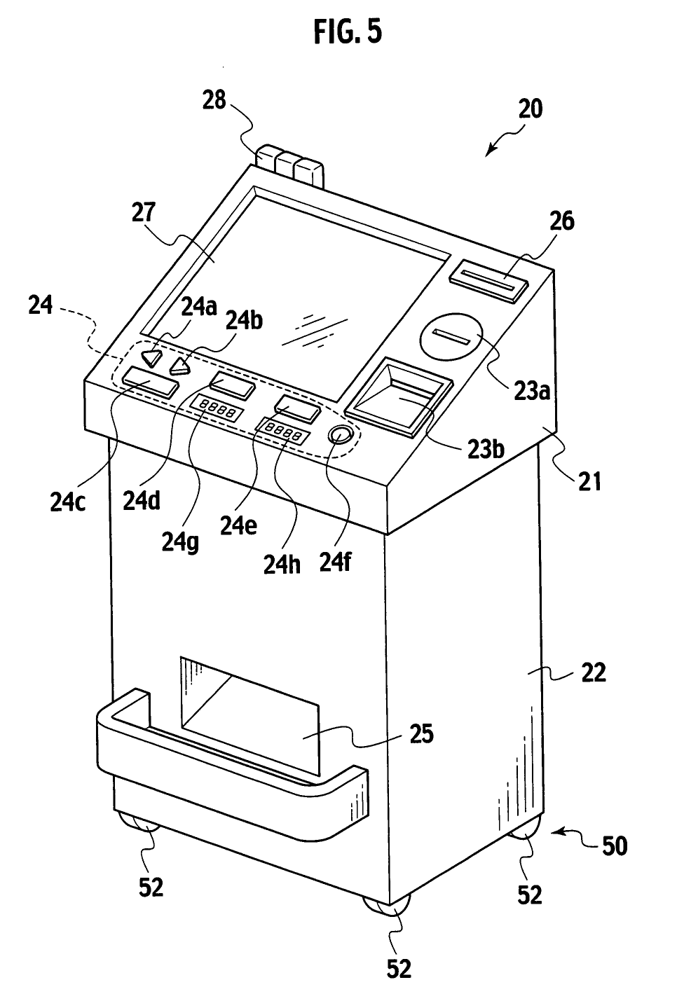

FIG. 5 is a perspective view of the client terminal 20. The client terminal 20 comprises an upper part 21 to which the player faces, and a lower part 22 for supporting the upper part 21. On a right side of the upper part 21, a medal insertion slot 23a and a bill insertion slot 23b are provided.

The medal insertion slot 23a is a portion for accepting inserted medals, and the bill insertion slot 23b is a portion for accepting the inserted bills. When the medals or the bills that are the gaming media are inserted at 23a and 23b, the amount of credits will be increased as much as the inserted amount inside the client terminal 20.

On a front side of the upper part 21, an operation panel 24 is provided. The operation panel 24 comprises game selection buttons 24a and 24b, a game determination button 24c, a bet switch 24d, a MAX bet switch 24e, a cashout switch 24f, a credit amount display unit 24g, and a bet amount display unit 24h.

The game selection buttons 24a and 24b are for selecting one of the roulette game, the horse racing game and the slot game. The game determination button 24c is a button to be pressed in order to play the game selected by the game selection buttons 24a and 24b. Namely, the player selects one of the three games by using the game selection buttons 24a and 24b, and it becomes possible to play that game by pressing the game determination button 24c in a state where one game is selected.

The bet switch 24d is a switch for betting credits on a specified location. For example, it is pressed at a time of purchasing a single bet ticket in the horse racing game, or at a time of betting on a specified number pocket in the roulette game. The MAX bet switch 24e is a switch for betting the maximum amount of credits. By pressing this switch, it is possible to bet on all paylines in the slot game, for example.

The cashout switch 24f is a switch for requesting the payout of credits. By pressing this switch, the medals will be ejected from and a medal ejection opening 25 provided on the lower part 22. From a ticket printer 26 provided on a right side of the upper part 21, a bar code attached ticket in which data such as the credit amount, the date and time, and the identification number of the client terminal 20 are coded will be outputted. The credit amount display unit 24g is for displaying the current credit amount, and the bet amount display unit 24h is for displaying the credit amount that is bet.

A liquid crystal display 27 has a transparent touch panel attached on its front face. The liquid crystal display 27 displays a betting operation screen for making detailed bets and a game screen for indicating the game progress state and the like. A selected game display lamp 28 is a lamp for indicating the game that is currently played by the player of the client terminal 20. By this lamp 28, each player can learn which game the other player is playing.

On a lower side of the lower part 22 of the client terminal 20, tires 52 which are constituent components of a moving device 50 are attached. It becomes possible for the client terminal 20 to move forward, backward, to the left or to the right by these tires 52.

The relay controller 40 transmits a moving information indicating a route by which it should move, to each client terminal 20. The moving device 50 rotates the tires 52 by activating a driving motor 51 to be described below, according to the moving information transmitted from the relay controller 40. In this way, the client terminal 20 is moved to a location from which one that is played by the player among the display devices 10 to 12 becomes easier to view.

Next, the internal configuration of each part of the gaming machine 1 shown in FIG. 3 will be described.

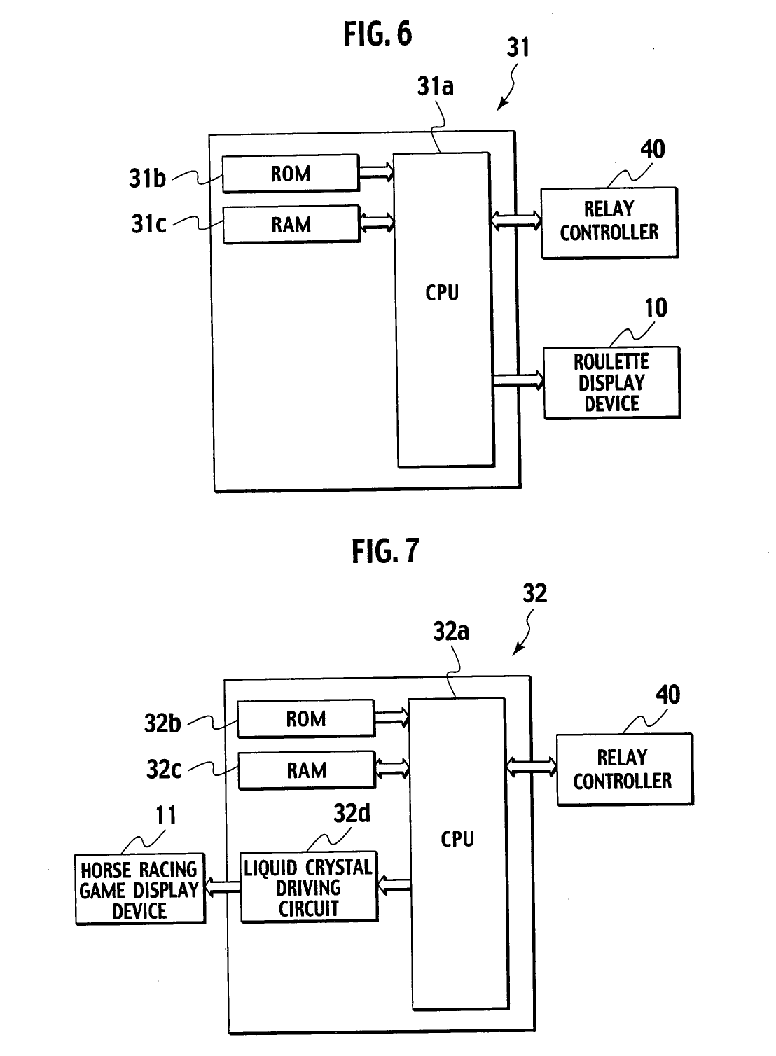

FIG. 6 is a block diagram showing an internal configuration of a first game controller 31. The first game controller 31 has a CPU 31a for carrying out the overall control of the first game controller 31, a ROM 31b, and a RAM 31c.

The CPU 31a is for carrying out various processings according to input signals supplied from the relay controller 40, and data and programs stored in the ROM 31b and the RAM 31c. This CPU 31a transmits command signals to the roulette display device 10 according to the processing results, and controls the roulette display device 10. More specifically, the CPU 31a controls the shooting of the ball and the rotation of the roulette wheel 103 in the roulette game.

The ROM 31b is formed by a semiconductor memory or the like, for example. This ROM 31b stores basic programs for realizing the roulette game. Also, the ROM 31b stores a payout table for the roulette game. Namely, the ROM 31b stores the betting methods such as “straight bet”, “cornet bet”, “split bet”, etc. and the rates of “×2” to “×36” corresponding to these betting methods.

The RAM 31c temporarily stores the amount of JP (jackpot) accumulated until now, and data regarding the result of the processing executed by the CPU 31a, etc.

FIG. 7 is a block diagram showing an internal configuration of a second game controller 32. The second game controller 32 has a CPU 32a for carrying out the overall control of the second game controller 32, a ROM 32b, a RAM 32c, and a liquid crystal driving circuit 32d.

The CPU 32a is for carrying out various processings according to input signals supplied from the relay controller 40, and data and programs stored in the ROM 32b and the RAM 32c. This CPU 32a controls the display content of the horse racing game display device 11 through the liquid crystal driving circuit 32d according to the processing results.

The ROM 32b is formed by a semiconductor memory or the like, for example. This ROM 32b stores basic programs for realizing the horse racing game. Also, the ROM 32b stores payout tables for the horse racing game. The payout rates regarding the horse racing game are changed in each game, so that the ROM 32b stores a plurality of payout tables. At a time of start accepting the betting operations, the CPU 32a reads out one payout table from a plurality of payout tables stored in the ROM 32b, and transmits its information to each client terminal through the relay controller 40. In this way, the payout rates regarding the horse racing game will be displayed on the liquid crystal display 27 of each client terminal 20.

The ROM 32b stores plural types of the race development. At a time of starting the race, the CPU 32a selects one race development from the plural types of race development stored in the ROM 32b, and proceeds with the game according to the selected race development.

The RAM 32c temporarily stores data regarding the result of the processing executed by the CPU 32a and the past game results, etc.

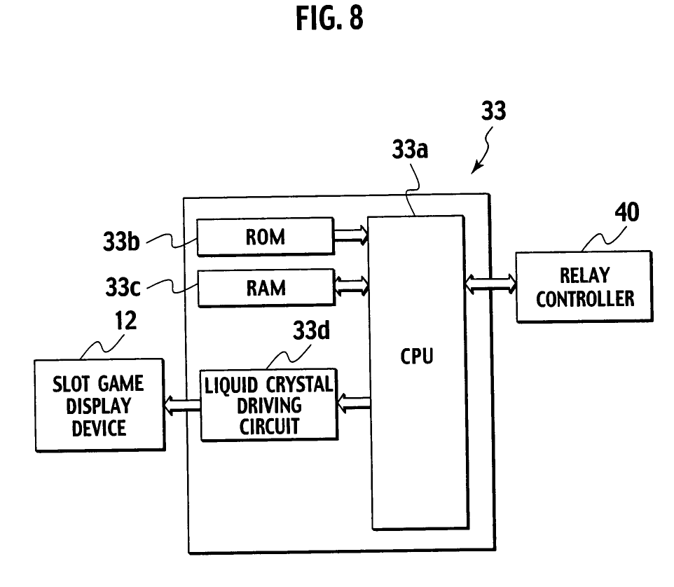

FIG. 8 is a block diagram showing an internal configuration of a third game controller 33. The third game controller 33 has a CPU 33a for carrying out the overall control of the third game controller 33, a ROM 33b, a RAM 33c, and a liquid crystal driving circuit 33d.

The CPU 33a is for carrying out various processings according to input signals supplied from the relay controller 40, and data and programs stored in the ROM 33b and the RAM 33c. This CPU 33a controls the display content of the slot game display device 12 through the liquid crystal driving circuit 33d according to the processing results.

The ROM 33b is formed by a semiconductor memory or the like, for example. This ROM 33b stores basic programs for realizing the slot game. Also, the ROM 33b stores a payout table for the slot game. This payout table is formed by symbols to be aligned and rates according to the symbols.

The RAM 33c temporarily stores data regarding the result of the processing executed by the CPU 33a and the past game results, etc.

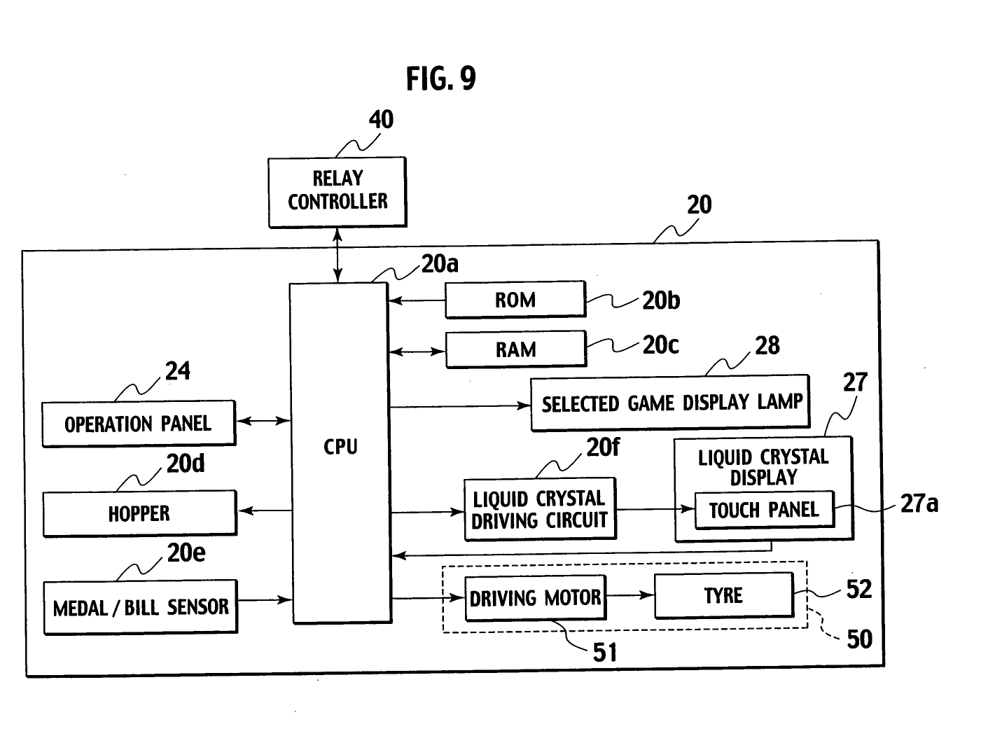

FIG. 9 is a block diagram showing an internal configuration of the client terminal 20. In addition to the configuration visible from the external as shown in FIG. 5, the client terminal 20 has a CPU 20a, a ROM 20b, a RAM 20c, a hopper 20d, a medal/bill sensor 20e, and a liquid crystal driving circuit 20f.

The CPU 20a is for carrying out various processings according to input signals and the moving information supplied from the relay controller 40, and data and programs stored in the ROM 20b and the RAM 20c.

The ROM 20b is formed by a semiconductor memory or the like, for example, and stores programs for realizing the basic functions of the client terminal 20, various other programs that are necessary in controlling the client terminal 20, and data tables, etc.

The RAM 20c temporarily stores various data calculated by the CPU 20a and the amount of credits accumulated in the client terminal 20, etc.

The hopper 20d is activated when the cashout switch 24f of the operation panel 24 is pressed, and pays as many medals as the amount of credits from the medal ejection opening 25. The medal/bill sensor 20e is for detecting types of the medals and the bills inserted from the medal insertion slot 23a and the bill insertion slot 23b. The detection information is transmitted to the CPU 20a. When this detection information is received, the CPU 20a increases the amount of credits according to the types of the medals and the bills, and displays that amount of credits at the credit amount display unit 24g of the operation panel 24. The liquid crystal driving circuit 20f makes the liquid crystal display 27 to display prescribed displays according to the command signals from the CPU 20a.

As shown in FIG. 9, the moving device 50 has the driving motor 51 for rotating the tires 52. When the moving information from the relay controller 40 is inputted, the CPU 20a generates the driving signals from this information, and transmit them to the driving motor 51. The driving motor 51 rotates the tires 52 according to these driving signals so as to move the client terminal 20.

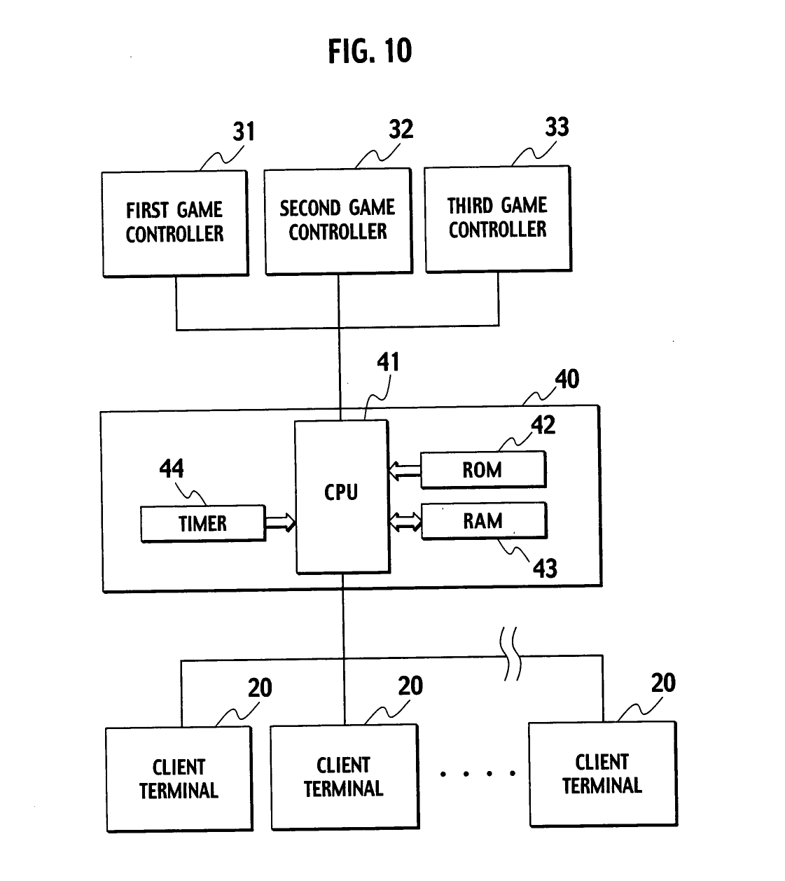

FIG. 10 is a block diagram showing an internal configuration of the relay controller 40. As shown in FIG. 10, the relay controller 40 has a CPU 41, a ROM 42, a RAM 43, and a timer 44.

The CPU 41 is for carrying out various processings according to information on the game results supplied from the game controllers 31 to 33, a time information of the timer 44, information on the betting operations from the client terminals 20 and the betting states, etc., and data and programs stored in the ROM 42 and the RAM 43.

The ROM 42 is formed by a semiconductor memory or the like, for example, and stores programs for realizing the basic functions of the relay controller 40, various other programs that are necessary in controlling the relay controller 40, and data tables, etc.

The RAM 43 temporarily stores information on the betting states transmitted from the client terminals 20 and the information on the current locations of the client terminals 20, etc.

The timer 44 is for carrying out a time measurement. The time information of the timer 44 is transmitted to the CPU 41. The CPU 41 measures the period for accepting the betting operations for each game or commands to each game, according to the time information of the timer 44.

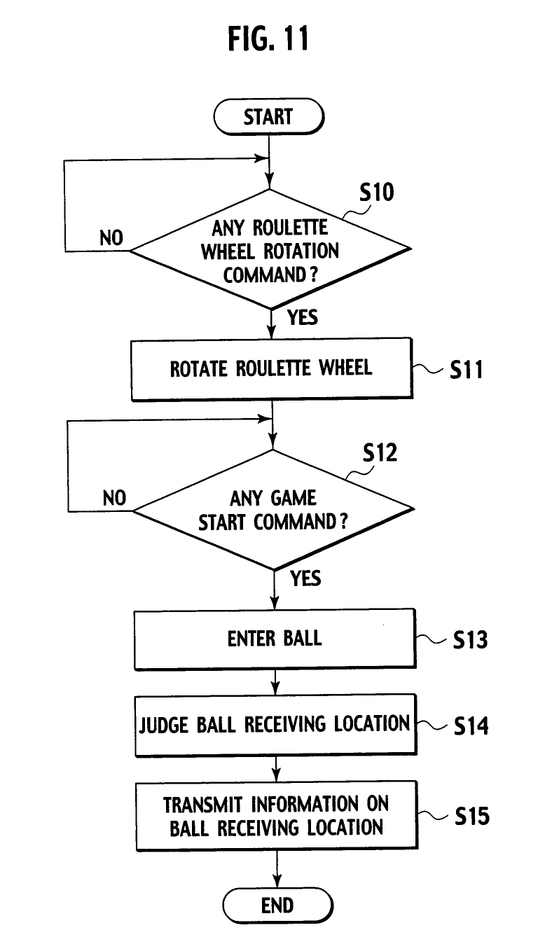

Next, the control method of the gaming machine 1 will be described. FIG. 11 is a flow chart showing the operation of the first game controller 31. As shown in FIG. 11, the first game controller 31 judges whether there is a rotation command for the roulette wheel 103 from the relay controller 40 or not first (step S10).

When it is judged that there is no rotation command for the roulette wheel 103 (step S10: NO), this processing is repeated until there is a rotation command. On the other hand, when it is judged that there is a rotation command for the roulette wheel 103 (step S10: YES), the first game controller 31 transmits an operation command to the driving motor (not shown) of the roulette display device 10, and rotates the roulette wheel 103 (step S11).

Next, the first game controller 31 judges whether there is a start command for the roulette game or not (step S12). When it is judged that there is no start command for the roulette game (step S12: NO), this processing is repeated until there is a start command. On the other hand, when it is judged that there is a start command for the roulette game (step S12: YES), the first game controller 31 transmits an operation command to the ball entering device of the roulette display device 10, and makes it enter the ball (step S13).

After that, the first game controller 31 judges the ball receiving location (step S14). At this point, the first game controller 31 judges the ball receiving location according to the signals of the sensors or the like provided on the roulette wheel 103.

Next, the first game controller 31 transmits information on the ball receiving location to the relay controller 40 (step S15), and finishes the processing shown in FIG. 11. Note that when the processing shown in FIG. 11 is finished, the ball will be collected.

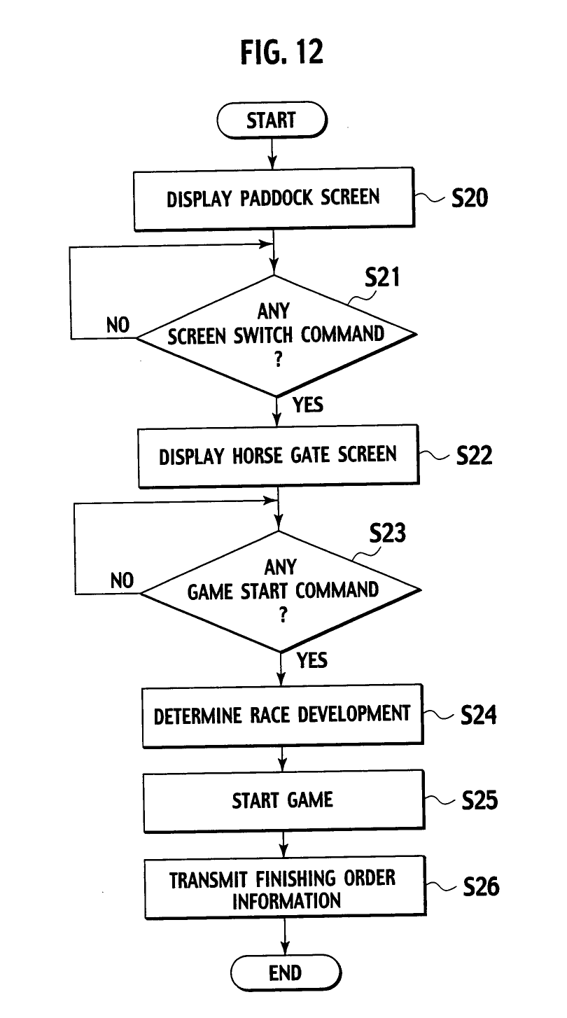

FIG. 12 is a flow chart showing the operation of the second game controller 32. As shown in FIG. 12, the second game controller 32 controls the liquid crystal driving circuit 32d to display a paddock screen on the horse racing game display device 11 first (step S20).

Next, the second game controller 32 judges whether there is a screen switch command from the relay controller 40 or not (step S21). When it is judged that there is no screen switch command (step S21: NO), this processing is repeated until there is a screen switch command. On the other hand, when it is judged that there is a screen switch command (step S21: YES), the second game controller 32 controls the liquid crystal driving circuit 32d to display a horse gate screen on the horse racing game display device 11 (step S22).

After that, the second game controller 32 judges whether there is a start command for the horse racing game or not (step S23). When it is judged that there is no start command for the horse racing game (step S23: NO), this processing is repeated until there is a start command. On the other hand, when it is judged that there is a start command for the horse racing game (step S23: YES), the second game controller 32 determines one race development from the race developments stored in the ROM 32b (step S24).

Then, the second game controller 32 starts the race (step S25). After the race is started, a screen in which horses are running will be displayed on the horse racing game display device 11. After that, when the race is finished, the second game controller 32 transmits the finishing order information to the relay controller 40 (step S26), and finishes the processing shown in FIG. 12.

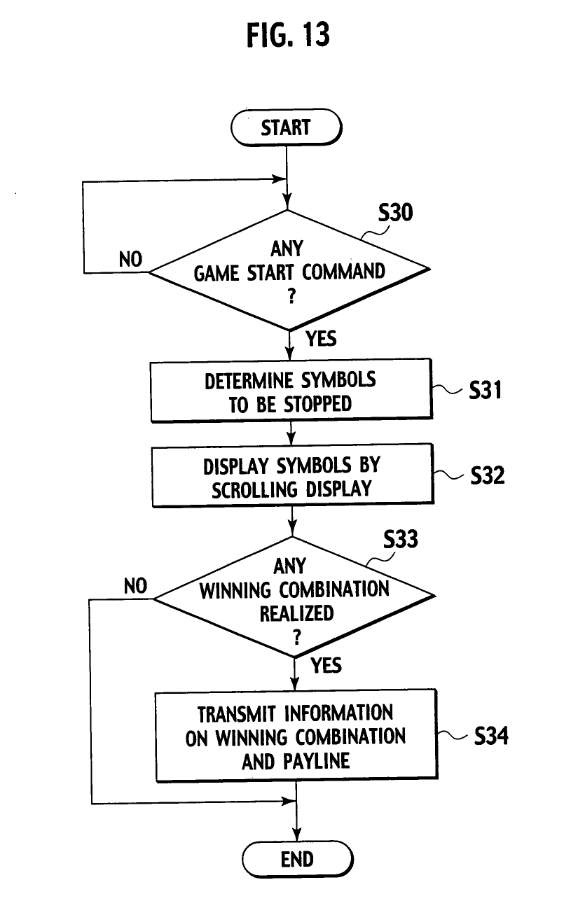

FIG. 13 is a flow chart showing the operation of the third game controller 33. As shown in FIG. 13, the third game controller 32 judges whether there is a start command for the slot game or not (step S30). When it is judged that there is no start command for the slot game (step S30: NO), this processing is repeated until there is a start command. On the other hand, when it is judged that there is a start command for the slot game (step S30: YES), the third game controller 33 determines symbols to be stopped (step S31). By this processing, symbols (“7”, “BELL”, “APPLE”, etc.) to be displayed at the slot game display device 12 are determined.

Next, the third game controller 33 controls the liquid crystal driving circuit 33d to display symbols in a scrolling display (step S32). Then, after a prescribed time has elapsed, symbols are stopped. The symbols stopped at this point are symbols determined at the step S32.

After that, the third game controller 33 judges whether symbols which become a winning combination are aligned or not (step S33). When symbols which become a winning combination are aligned (step S33: YES), the third game controller 33 transmits information on this winning combination and a payline on which they are aligned to the relay controller 40 (step S34), and then finishes the processing shown in FIG. 13.

On the other hand, when symbols which become a winning combination are not aligned (step S33: NO), the third game controller 33 finishes the processing shown in FIG. 13, without transmitting information to the relay controller 40.

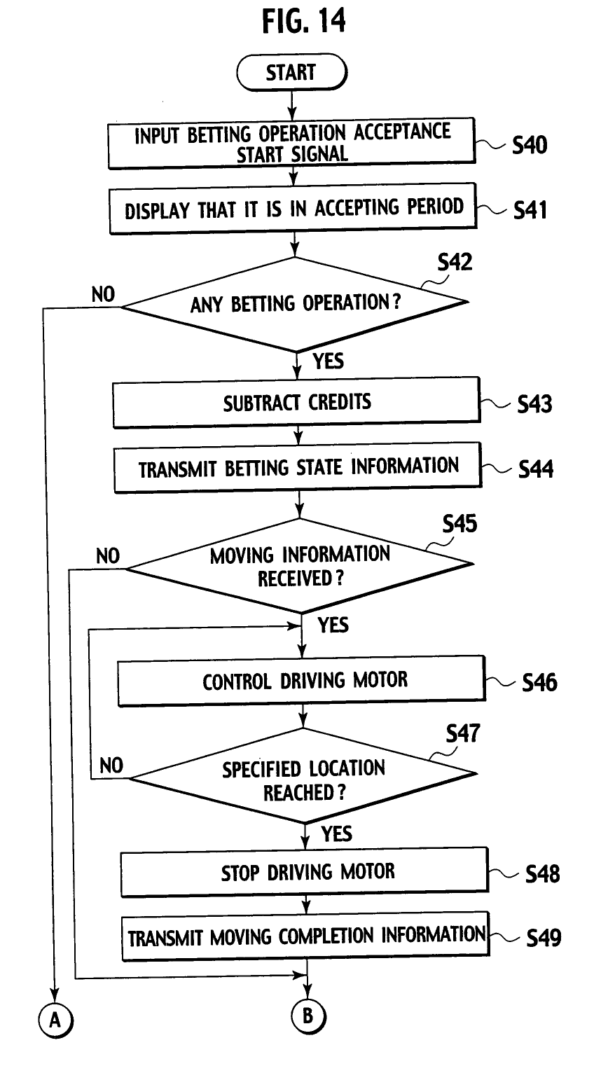

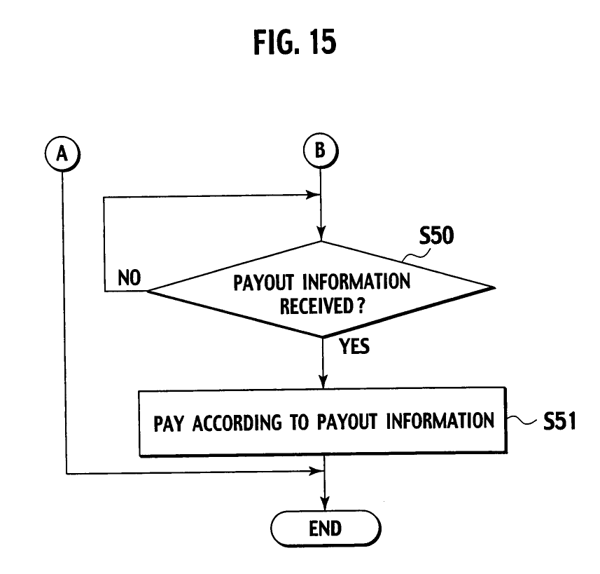

FIG. 14 and FIG. 15 are a flow chart showing the operation of the client terminal 20 and the moving device 50. As shown in FIG. 14, the CPU 20a of the client terminal 20 receives an input of the acceptance start signal indicating that it is start accepting the betting operations for one game among the three games, from the relay controller 40 (step S40). As a result, the CPU 20a of the client terminal 20 will display the fact that it is in the accepting period at the liquid crystal display 27 (step S41).

Next, the CPU 20a judges whether there is any betting operation made by the player within the accepting period or not (step S42). When it is judged that there is no betting operation is made by the player (step S42: NO), the processing shown in FIG. 14 and FIG. 15 is finished. On the other hand, when it is judged that there is abetting operation made by the player (step S42: YES), the CPU 20a subtracts the amount of credits that is bet from the current amount of credits (step S43), and displays the subtracted amount at the credit amount display unit 24g.

Next, the CPU 20a transmits information on the betting state indicating what bets were made by the player to the relay controller 40 at a time of finishing the betting operation accepting period (step S44). After that, the CPU 20a judges whether the moving information from the relay controller 40 is received or not (step S45).

When it is judged that the moving information is not received (step S45: NO), the processing proceeds to the step S50 of FIG. 15. On the other hand, when it is judged that the moving information is received (step S45: YES), the CPU 20a generates the driving signals according to the moving information, and drives the driving motor 51 (step S46). After that, the CPU 20a judges whether the specified location indicated by the moving information is reached or not (step S47).

When it is judged that the specified location is not reached (step S47: NO), the processing proceeds to the step S46. On the other hand, when it is judged that the specified location is reached (step S47: YES), the CPU 20a stops the driving motor 51 (step S48). After that, the client terminal 20 transmits the moving completion information to the relay controller 40 (step S49).

Next, as shown in FIG. 15, the CPU 20a judges whether the payout information from the relay controller 40 is received or not (step S50). Here, the payout information is an information indicating the amount of credits to be paid to the player. When it is judged that the payout information is not received (step S50: NO), this processing is repeated until it is judged as received.

On the other hand, when it is judged that the payout information is received (step S50: YES), the CPU 20a generates the payout according to the payout information (step S51). Then, the processing shown in FIG. 14 and FIG. 15 is finished.

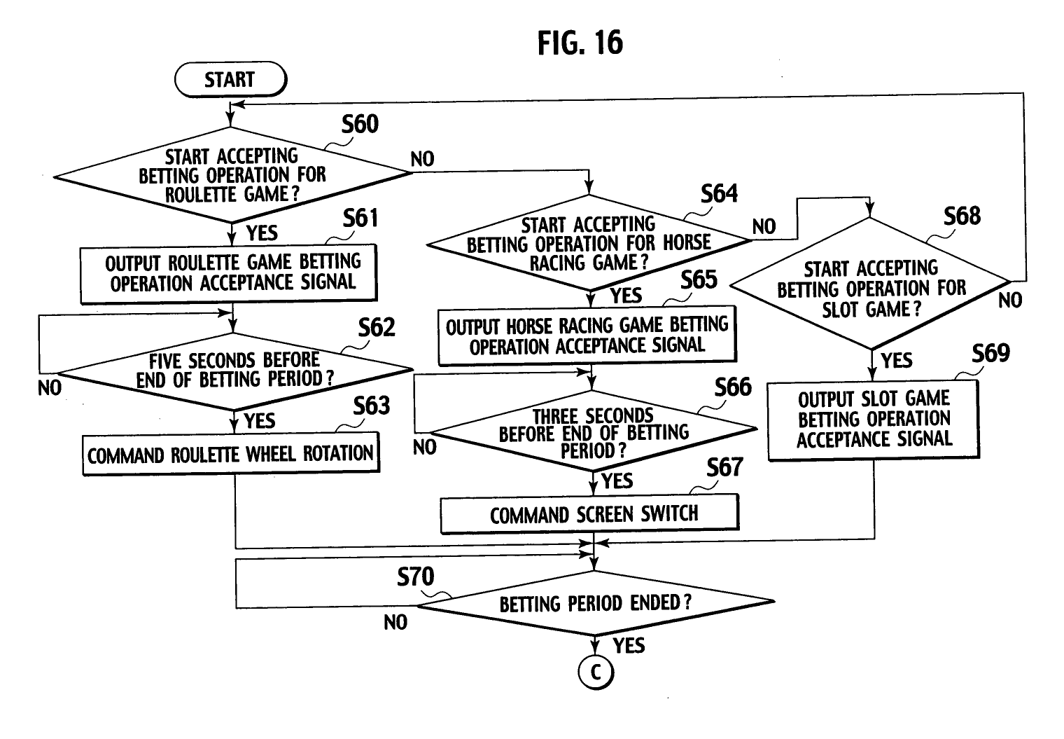

FIG. 16 to FIG. 18 are a flow chart showing the operation of the relay controller 40. As shown in FIG. 16, the relay controller 40 judges whether it is currently a start of accepting the betting operation for the roulette game or not according to the information of the timer 44 and the like first (step S60). When it is judged that it is a start of accepting the betting operation for the roulette game (step S60: YES), the relay controller 40 outputs the betting operation acceptance signal for the roulette game with respect to each client terminal 20 (step S61). As a result, the fact that it is currently in the accepting period for the roulette game is displayed at the client terminal 20.

After that, the relay controller 40 judged whether it is last 5 seconds of the betting operation accepting period or not (step S62). When it is judged that it is not last 5 seconds of the accepting period (step S62: NO), this processing is repeated until it becomes last 5 seconds of the accepting period. When it is judged that it is last 5 seconds of the accepting period (step S62: YES), the relay controller 40 issues the rotation command for the roulette wheel 103 to the first game controller 31 (step S63). After that, the processing proceeds to the step S70.

Also, when it is judged that it is not a start of accepting the betting operation for the roulette game (step S60: NO), the relay controller 40 judges whether it is a start of accepting the betting operation for the horse racing game or not (step S64). When it is judged that it is a start of accepting the betting operation for the horse racing game (step S64: YES), the relay controller 40 outputs the betting operation acceptance signal for the horse racing game with respect to each client terminal 20 (step S65). As a result, the fact that it is currently in the accepting period for the horse racing game is displayed at the client terminal 20.

After that, the relay controller 40 judged whether it is last 3 seconds of the betting operation accepting period or not (step S66). When it is judged that it is not last 3 seconds of the accepting period (step S66: NO), this processing is repeated until it becomes last 3 seconds of the accepting period. When it is judged that it is last 3 seconds of the accepting period (step S66: YES), the relay controller 40 issues the screen switch command to the second game controller 32 (step S67). After that, the processing proceeds to the step S70.

Also, when it is judged that it is not a start of accepting the betting operation for the horse racing game (step S64: NO), the relay controller 40 judges whether it is a start of accepting the betting operation for the slot game or not (step S68). When it is judged that it is a start of accepting the betting operation for the slot game (step S68: YES), the relay controller 40 outputs the betting operation acceptance signal for the slot game with respect to each client terminal 20 (step S69). As a result, the fact that it is currently in the accepting period for the slot game is displayed at the client terminal 20. After that, the processing proceeds to the step S70. On the other hand, when it is judged that it is not a start of accepting the betting operation for the slot game (step S68: NO), the processing proceeds to the step S60.

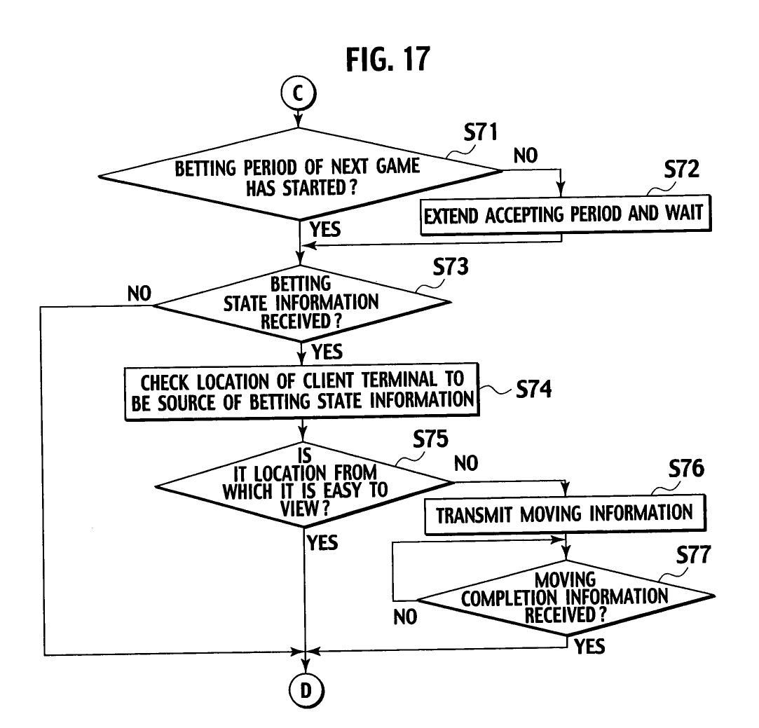

At the step S70, the relay controller 40 judged whether it is an end of the betting operation accepting period or not (step S70). When it is judged that it is not an end of the betting operation accepting period (step S70: NO), this processing is repeated until it is judged that it is an end of the accepting period. On the other hand, when it is judged that it is an end of the betting operation accepting period (step S70: YES), the relay controller 40 judges whether the betting operation accepting period for the next game has started or not (FIG. 17: step S71).

When it is judged that the betting operation accepting period for the next game has started (step S71: YES), the processing proceeds to the step S73. On the other hand, when it is judged that the betting operation accepting period for the next game has not started (step S71: NO), the relay controller 40 extends the accepting period for the current game until the betting operation accepting period for the next game starts, and waits until the extended period ends (step S72). After that, the processing proceeds to the step S73.

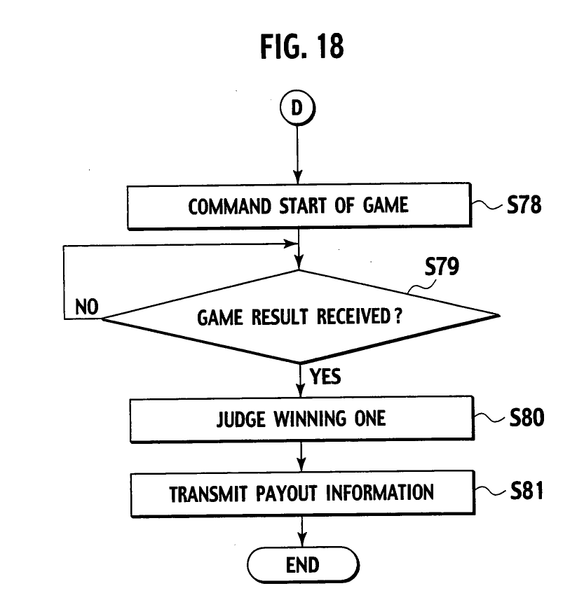

At the step S73, the relay controller 40 judged whether the betting state information is received or not (step S73). When it is judged that the betting state information is not received (step S73: NO), the processing proceeds to the step S78 of FIG. 18. When it is judged that the betting state information is received (step S73: YES), the relay controller 40 checks the location of the client terminal 20 which is a source of the betting state information (step S74).

Next, the relay controller 40 judged whether all the client terminals 20 are existing at locations from which the display devices 11 to 13 of the game for which the accepting period is ended can be viewed easily or not (step S75). When it is judged that all the client terminals 20 are existing at locations from which the display devices 11 to 13 of the game for which the accepting period is ended can be viewed easily (step S75: YES), the processing proceeds to the step S78 of FIG. 18.

When it is judged that not all the client terminals 20 are existing at locations from which the display devices 11 to 13 of the game for which the accepting period is ended can be viewed easily, that is, when it is judged that even one of them is located at a location from which the display devices 11 to 13 cannot be viewed easily (step S75: NO), the relay controller 40 transmits the moving information to the client terminal 20 that is existing at a location from which they cannot be viewed easily (step S76). After that, the relay controller 40 judges whether the moving completion information is received from all the client terminals 20 to which the moving information has been transmitted or not (step S77).

When it is judged that the moving completion information is not received from all the client terminals 20 (step S77: NO), this processing is repeated until the moving completion information is received. On the other hand, when it is judged that the moving completion information is received from all the client terminals 20 (step S77: YES), the processing proceeds to the step S78 of FIG. 18.

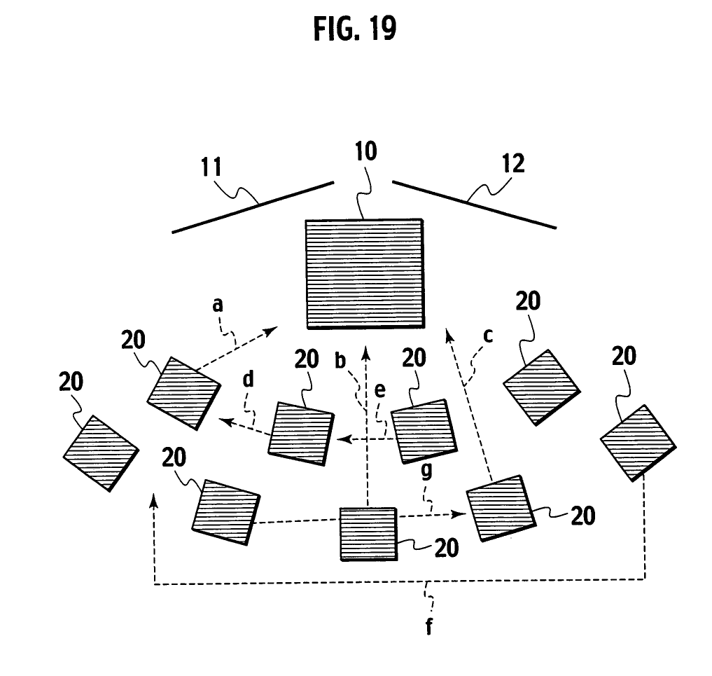

Here, the exemplary moving of the client terminals 20 will be described. FIG. 19 is a diagram showing one example of a moving of the client terminals 20. For example, in the case of moving the client terminals 20 to a location from which it is easy to view the roulette display device 10, the relay controller 40 moves the client terminals 20 forward as indicated by arrows a to c, for example. Also, in the case of moving the client terminals 20 to a location from which it is easy to view the horse racing game display device 11, the relay controller 40 moves the client terminals 20 to the left side as indicated by arrows d to f, for example. Also, in the case of moving the client terminals 20 to a location from which it is easy to view the slot game display device 12, the relay controller 40 moves the client terminals 20 to the right side as indicated by an arrow g, for example.

Referring to FIG. 18 again, at the step S78, the relay controller 40 commands the game start to the game controllers 31 to 33 for the game for which the accepting period is ended (step S78). As a result, the entering of the ball in the roulette game, or the race start in the horse racing game, or the symbol scrolling in the slot game will be carried out. In this way, the game is started after the moving of the client terminals 20 is completed, so that it is possible to prevent a situation in which the game proceeds while it is difficult to view the display devices 10 to 12 as it is still in a process of moving. Also, the moving of the client terminals 20 is carried out after the accepting period is ended, so that it is possible to suppress a situation in which the players are surprised as the client terminals 20 are moved while the betting operation is made.

After that, the relay controller 40 judged whether the game result is received or not (step S79). Namely, the relay controller 40 judges whether the information on the ball receiving location for the roulette game, or the finishing order information for the horse racing game, or the information on the winning combination and the payline for the slot game, is received or not. Here, when it is judged that the game result is not received (step S79: NO), this processing is repeated until it is judged that the game result is received.

When it is judged that the game result is received (step S79: YES), the relay controller 40 makes the winning judgement according to the betting state information received at the step S73 and the game result (step S80). After that, the relay controller generates the payout information according to the result of the winning judgement, and transmits the payout information to each client terminal 20 which has transmitted the betting state information (step S81). After that, the processing shown in FIG. 16 to FIG. 18 is finished. Note that the processing of the steps S80 and S81 will not be executed in the case where the betting state information is not received at the step S73.

In the above, the embodiment of the present invention has been described, but it is only showing a concrete example. Namely, the embodiment of the present invention does not limit the present invention, and the concrete configuration of each means or the like can be modified in design appropriately. Also, the effects described in the embodiment of the present invention are only listing the most preferable effects that can arise from the present invention, and the effects of the present invention are not limited to those described in the embodiment of the present invention.

Also, in the detailed description above, the characteristic portions are mainly described in order to make the present invention easily understandable. The present invention is not limited to the embodiment described in the detailed description above, and can be applied to the other embodiments, and its range of application is wide. Also, the terms and the terminology used in the present specification are used only for the purpose of explaining the present invention precisely, and not used for the purpose of limiting the interpretation of the present invention. Also, for those skilled in the art, it should be easy to contemplate other configurations, systems, methods, etc., that are contained in the concept of the present invention, from the content of the invention described in the present specification. Consequently, the description of the scope of claims should be construed as containing equivalent configurations within a range of not deviating from a range of the technical ideas of the present invention.

Also, in the present specification, each step used in deriving one result should be understood as a processing without a self-contradiction. Also, there are cases where the processing at each step is described by an expression common to the human behavior, but the processing described in the present specification is to be executed by various devices in principle. Also, the other configuration required in carrying out each step will be obvious from the above description.

What is claimed is:

1. A gaming machine comprising:
a plurality of displays configured to respectively display a plurality of games in which a plurality of players can participate;
a plurality of client terminals configured to accept betting operations for betting gaming media with respect to each of the plurality of games;
a moving device configured to move the plurality of client terminals; and
a controller operable to control the moving device to move the plurality of client terminals such that it becomes easier for a player of each client terminal at which a betting operation is made to view a display which displays a game with respect to which the betting operation is made.

2. The gaming machine of claim 1, wherein the controller extends a period for accepting the betting operations in one game among the plurality of games at least until a period for accepting the betting operations in at least one other game starts.

3. The gaming machine of claim 1, wherein each of the plurality of client terminals has a display device configured to display information on games which are currently in their periods for accepting the betting operations.

4. A gaming machine comprising:
a plurality of displays configured to respectively display a plurality of games in which a plurality of players can participate;
a plurality of client terminals configured to accept betting operations for betting gaming media by guessing a game result of each of the plurality of games;
a moving device configured to move the plurality of client terminals; and
a controller operable to:
(a) control the moving device to move the plurality of client terminals such that it becomes easier for a player of each client terminal at which a betting operation is made to view a display which displays a game with respect to which the betting operation is made; and
(b) and start a game after a moving of the plurality of client terminals is completed.

5. The gaming machine of claim 4, wherein the controller extends a period for accepting the betting operations in one game among the plurality of games at least until a period for accepting the betting operations in at least one other game starts.

6. The gaming machine of claim 4, wherein each of the plurality of client terminals has a display device configured to display information on games which are currently in their periods for accepting the betting operations.

7. A gaming machine comprising:
a plurality of displays configured to respectively display a plurality of games in which a plurality of players can participate;
a plurality of client terminals configured to accept betting operations for betting gaming media by guessing a game result of each of the plurality of games;
a moving device configured to move the plurality of client terminals; and
a controller operable to:
(a) measure a period for accepting the betting operations;
(b) control the moving device to move the plurality of client terminals such that it becomes easier for a player of each client terminal at which a betting operation is made to view a display which displays a game with respect to which the betting operation is made after the period for accepting the betting operations is finished; and
(c) start a game after a moving of the plurality of client terminals is completed.

8. The gaming machine of claim 7, wherein the controller extends a period for accepting the betting operations in one game among the plurality of games at least until a period for accepting the betting operations in at least one other game starts.

9. The gaming machine of claim 7, wherein each of the plurality of client terminals has a display device configured to display information on games which are currently in their periods for accepting the betting operations.

10. A method for controlling a gaming machine, the method comprising the steps of:
accepting betting operations for betting gaming media from a plurality of client terminals, with respect to each of a plurality of games in which a plurality of players can participate through the plurality of client terminals;
judging a display displaying a game with respect to which a betting operation is made, among a plurality of displays configured to respectively display the plurality of games; and
moving the plurality of client terminals such that it becomes easier for a player of each client terminal at which a betting operation is made to view a display which displays a game with respect to the betting operation is made, according to results in the judging step.

11. The method of claim 10, further comprising the step of extending a period for accepting the betting operations in one game among the plurality of games at least until a period for accepting the betting operations in at least one other game starts.

12. The method of claim 10, further comprising the step of displaying information on games which are currently in their periods for accepting the betting operations, at a display device of each of the plurality of client terminals.

13. A method for controlling a gaming machine, the method comprising the steps of:
accepting betting operations for betting gaming media from a plurality of client terminals, with respect to each of a plurality of games in which a plurality of players can participate through the plurality of client terminals;
judging a display displaying a game with respect to which a betting operation is made, among a plurality of displays configured to respectively display the plurality of games;
moving the plurality of client terminals such that it becomes easier for a player of each client terminal at which a betting operation is made to view a display which displays a game with respect to the betting operation is made, according to results in the judging step; and
starting a game after a moving of the plurality of client terminals is completed.

14. The method of claim 13, further comprising the step of extending a period for accepting the betting operations in one game among the plurality of games at least until a period for accepting the betting operations in at least one other game starts.

15. The method of claim 13, further comprising the step of displaying information on games which are currently in their periods for accepting the betting operations, at a display device of each of the plurality of client terminals.

16. A method for controlling a gaming machine, the method comprising the steps of:
accepting betting operations for betting gaming media from a plurality of client terminals, with respect to each of a plurality of games in which a plurality of players can participate through the plurality of client terminals;
judging a display displaying a game with respect to which a betting operation is made, among a plurality of displays configured to respectively display the plurality of games, after a period for accepting the betting operations is finished;
moving the plurality of client terminals such that it becomes easier for a player of each client terminal at which a betting operation is made to view a display which displays a game with respect to the betting operation is made, according to results in the judging step; and
starting a game after a moving of the plurality of client terminals is completed.

17. The method of claim 16, further comprising the step of extending a period for accepting the betting operations in one game among the plurality of games at least until a period for accepting the betting operations in at least one other game starts.

18. The method of claim 16, further comprising the step of displaying information on games which are currently in their periods for accepting the betting operations, at a display device of each of the plurality of client terminals.
